(19) United States
(12) Patent Application Publication
(10) Pub. No.: US 2014/0009384 A1
(43) Pub. Date: Jan. 9, 2014

(54) METHODS AND SYSTEMS FOR DETERMINING LOCATION OF HANDHELD DEVICE WITHIN 3D ENVIRONMENT

(71) Applicant: 3DIVI, Miass (RU)

(72) Inventors: Andrey Valik, Miass (RU); Pavel Zaitsev, Miass (RU); Dmitry Morozov, Miass (RU); Alexander Argutin, Miass (RU)

(73) Assignee: 3DIVI, Miass (RU)

(21) Appl. No.: 13/855,743

(22) Filed: Apr. 3, 2013

Related U.S. Application Data
(63) Continuation-in-part of application No. 13/541,684, filed on Jul. 4, 2012.

(51) Int. Cl. G06F 3/01

(52) U.S. Cl. CPC G06F 3/017
USPC 345/156

(57) ABSTRACT

The present technology refers to methods for dynamic determining location and orientation of handheld device, such as a smart phone, remote controller or gaming device, within a 3D environment in real time. For these ends, there is provided a 3D camera for capturing a depth map of the 3D environment within which there is a user holding the handheld device. The handheld device acquires motion and orientation data in response to hand gestures, which data is further processed and associated with a common coordinate system. The depth map is also processed to generate motion data of user hands, which is then dynamically compared to the processed motion and orientation data obtained from the handheld device so as to determine the handheld device location and orientation. The positional and orientation data may be further used in various software applications to generate control commands or perform analysis of various gesture motions.

### CROSS-REFERENCE TO RELATED APPLICATIONS

This application is Continuation-in-Part of U.S. Utility patent application Ser. No. 13/541,684, filed on Jul. 4, 2012, which is incorporated herein by reference in its entirety for all purposes.

### TECHNICAL FIELD

This disclosure relates generally to human-computer interfaces and, more particularly, to the technology of determining a precise location and orientation of a handheld device, such as a smart phone, remote controller, or a gaming device, within a three-dimensional (3D) environment in real time by intelligent combining motion data acquired by a 3D camera and motion data acquired by the handheld device itself.

### DESCRIPTION OF RELATED ART

The approaches described in this section could be pursued, but are not necessarily approaches that have previously been conceived or pursued. Therefore, unless otherwise indicated, it should not be assumed that any of the approaches described in this section qualify as prior art merely by virtue of their inclusion in this section.

Technologies associated with human-computer interaction have evolved over the last several decades. There are currently many various input devices and associated interfaces that enable computer users to control and provide data to their computers. Keyboards, pointing devices, joysticks, and touchscreens are just some examples of input devices that can be used to interact with various software products. One of the rapidly growing technologies in this field is the gesture recognition technology which enables the users to interact with the computer naturally, using body language rather than mechanical devices. In particular, the users can make inputs or generate commands using gestures or motions made by hands, arms, fingers, legs, and so forth. For example, using the concept of gesture recognition, it is possible to point a finger at the computer screen and cause the cursor to move accordingly.

There currently exist various gesture recognition control systems (also known as motion sensing input systems) which, generally speaking, include a 3D camera (also known as depth sensing camera), which captures scene images in real time, and a computing unit, which interprets captured scene images so as to generate various commands based on identification of user gestures. Typically, the gesture recognition control systems have very limited computation resources. Also, the small resolution of the depth sensing camera makes it difficult to identify and track motions of relatively small objects such as handheld devices.

Various handheld devices may play an important role for human-computer interaction, especially, for gaming software applications. The handheld devices may refer to controller wands, remote control devices, or pointing devices which enable the users to generate specific commands by pressing dedicated buttons arranged thereon. Alternatively, commands may be generated when a user makes dedicated gestures using the handheld devices such that various sensors imbedded within the handheld devices may assist in determining and tracking user gestures. Accordingly, the computer can be controlled via the gesture recognition technology, as well as by the receipt of specific commands originated by pressing particular buttons.

Typically, the gesture recognition control systems, when enabled, monitor and track all gestures performed by users. However, to enable the gesture recognition control systems to identify and track a motion of a relatively small handheld device, a high resolution depth sensing camera and immoderate computational resources may be needed. It should be noted that state of the art 3D cameras, which capture depth maps, have a very limited resolution and high latency. This can make it difficult, or even impossible, for such systems to precisely locate the relatively small handheld device at the depth map and determine parameters such as its orientation, coordinates, size, type, and motion. Today's handheld devices, on the other hand, may also include various inertial sensors which dynamically determine their motion and orientation. However, this information is insufficient to determine a location and orientation of the handheld devices within the 3D environment within which they are used. In some additional conventional gesture recognition control systems, the handheld devices may also include specific auxiliary modules, such as a lighting sphere or dedicated coloring , facilitating their identification and tracking by a conventional camera or 3D camera. In yet another example, the handheld device may also imbed an infra-red (IR) sensor or a 3D camera so as to continuously monitor the position of the handheld device in relation to a target screen, e.g. a TV screen or another device.

In view of the above, in order to precisely determine the position and orientation of handheld device in a 3D environment, the gesture recognition control system may need to use incredibly large computational resources and high resolution 3D cameras or, alternatively, the handheld devices may need to use ad hoc sensors, 3D cameras or other complex auxiliary devices to determine their position and orientation. Either one of the above described approaches is disadvantageous and increases costs of the gesture recognition control systems. In view of the foregoing, there is still a need for improvements of gesture recognition control systems that will enhance interaction effectiveness and reduce required computational resources.

### SUMMARY

This summary is provided to introduce a selection of concepts in a simplified form that are further described in the Detailed Description below. This summary is not intended to identify key or essential features of the claimed subject matter, nor is it intended to be used as an aid in determining the scope of the claimed subject matter.

The present disclosure refers to gesture recognition control systems configured to identify various user gestures and generate corresponding control commands. More specifically, the technology disclosed herein may determine and track a current location and orientation of a handheld device based upon comparison of data acquired by a 3D camera, and data acquired from the handheld device. Accordingly, the present technology allows determining a current location, and optionally, an orientation of handheld device within a 3D environment using typical computational resources, which is accomplished without the necessity of using dedicated auxiliary devices such as a lighting sphere. According to one or more embodiments of the present disclosure, the gesture recognition control system may include a depth sensing camera, also known as a 3D camera, which is used for obtaining a depth map of a 3D environment, within which at least one user is present. The user may hold a handheld device, such as a game pad or smart phone, in at least one hand.

The gesture recognition control system may further include a communication module for receiving, from the handheld device, handheld device motion data and handheld device orientation data associated with at least one motion of the handheld device. The handheld device motion data and handheld device orientation data may be generated by one or more sensors of the handheld device, which sensors may include, for example, accelerometers, gyroscopes, and magnetometers. Accordingly, the handheld device motion data and handheld device orientation data may be associated with a coordinate system of the handheld device.

The gesture recognition control system may further include a computing unit, communicatively coupled to the depth sensing device and the wireless communication unit. The computing unit may be configured to process the depth map and identify on it at least one user, at least one user hand, and one or more motions of the at least one user hand. The computing unit may generate a virtual skeleton of the user, which skeleton may have multiple virtual joints having coordinates on a 3D coordinate system associated with the depth map. Accordingly, once a motion of the at least one user hand is identified, the computing unit obtains a corresponding set of coordinates on the 3D coordinate system associated with the depth map. In this regard, when the motion of the at least one user hand holding the handheld device is identified, the computing unit generates first motion data having at least this set of coordinates.

Further, the handheld device motion data may be corresponded with the 3D coordinate system associated with the depth map. For this purpose, the handheld device motion data may be transformed utilizing the handheld device orientation data and optionally a correlation matrix. The transformed handheld device motion data may now constitute second motion data.

The computing unit further compares (maps) the first motion data to the second motion data so as to find correlation between the motion of the at least one user hand identified on the depth map and the motion of the handheld device itself. Once such correlation is found, the computing unit may assign the set of coordinates associated with the at least one user hand making the motion to the handheld device.

Thus, the precise location and orientation of the handheld device may be determined, which may be then used in many various software applications and/or for generation of control commands for auxiliary devices such as a game console or the like.

According to one or more embodiments of the present disclosure, there is also provided a method for determining a location (an optionally an orientation) of a handheld device within a 3D environment. The method may comprise acquiring, by a processor communicatively coupled with a memory, a depth map from at least one depth sensing device. The depth map may be associated with a first coordinate system. The method may further include processing, by the processor, the depth map to identify at least one motion of at least one user hand. The method may further include generating, by the processor, first motion data associated with the at least one motion of the at least one user hand. The first motion data may include a set of coordinates associated with the at least one user hand.

The method may further include acquiring, by the processor, handheld device motion data and handheld device orientation data associated with at least one motion of the handheld device. The handheld device motion data and the handheld device orientation data may be associated with a second coordinate system.

The method may further include generating, by the processor, second motion based at least in part on the handheld device motion data and the handheld device orientation data. The method may further include comparing, by the processor, the first motion data to the second motion data to determine that the at least one motion of the handheld device is correlated with the at least one motion of the at least one user hand.

The method may further include ascertaining, by the processor, coordinates of the handheld device on the first coordinate system based on the determination. The ascertaining of the coordinates of the handheld device on the first coordinate system may include assigning, by the processor, the set of coordinates associated with the at least one user hand to the handheld device.

In certain embodiments, the generating of the second motion data may comprises multiplying, by the processor, the handheld device motion data by a correlation matrix and a rotation matrix, wherein the rotation matrix is associated with the handheld device orientation data. In certain embodiments, the rotation matrix may refer to at least one of a current rotation matrix, instantaneous rotation matrix, calibrated rotation matrix, or calibrated instantaneous rotation matrix. In certain embodiments, the method may further comprise determining, by the processor, one or more orientation vectors of the handled device within the first coordinate system based at least in part on the handheld device orientation data. In certain embodiments, the method may further comprise generating, by the processor, a virtual skeleton of a user, the virtual skeleton comprises at least one virtual joint of the user. The at least one virtual joint of the user may be associated with the first coordinate system.

In certain embodiments, the processing of the depth map may further comprise determining, by the processor, coordinates of the at least one user hand on the first coordinate system. The coordinates of the at least one user hand may be associated with the virtual skeleton. The processing of the depth map may further comprise determining, by the processor, that the at least one user hand, which makes the at least one motion, holds the handheld device. In certain embodiments, the second motion data includes at least acceleration data. The handheld device orientation data may include at least one of: rotational data, calibrated rotational data or an attitude quaternion associated with the handheld device.

In certain embodiments, the method may further comprise determining, by the processor, that the handheld device is in active use by the user. The handheld device is in active use by the user, when the handheld device is held and moved by the user and when the user is identified on the depth map. In certain embodiments, the method may further comprise generating, by the processor, a control command for an auxiliary device based at least in part on the first motion data or the second motion data.

According to one or more embodiments of the present disclosure, there is also provided a system for determining a location of a handheld device within a 3D environment. The system may comprise a depth sensing device configured to obtain a depth map of the 3D environment within which at least one user is present, a wireless communication module configured to receive from the handheld device handheld device motion data and handheld device orientation data associated with at least one motion of the handheld device, and a computing unit communicatively coupled to the depth sensing device and the wireless communication unit. In various embodiments, the computing unit may be configured to identify, on the depth map, a motion of at least one user hand. The computing unit may be further configured to determine, by processing the depth map, coordinates of the at least one user hand on a first coordinate system. The computing unit may be further configured to generate first motion data associated with the at least one motion of the user hand. The first motion data may be associated with the coordinates of the at least one user hand on the first coordinate system. The computing unit may be further configured to generate second motion data by associating the handheld device motion data with the first coordinate system. The computing unit may be further configured to compare the first motion data and the second motion data so as to determine correlation therebetween and, based on the correlation, assign the coordinates of the at least one user hand on the first coordinate system to the handheld device.

In various embodiments, the handheld device may be selected from a group comprising: an electronic pointing device, a cellular phone, a smart phone, a remote controller, a video game console, a video game pad, a handheld game device, a computer, a tablet computer, and a sports implement. The depth map may be associated with the first coordinate system. The handheld device motion data and the handheld device orientation data may be associated with a second coordinate system. In various embodiments, the associating of the handheld device motion data with the first coordinate system may include transforming the handheld device motion data based at least in part on handheld device orientation data. The computing unit may be further configured to generate a virtual skeleton of the user (the virtual skeleton comprising at least one virtual limb associated with the at least one user hand), determine coordinates of the at least one virtual limb, and associate the coordinates of the at least one virtual limb, which relates to the user hand making the at least one motion, to the handheld device.

In further example embodiments, the above methods steps are stored on a processor-readable non-transitory medium comprising instructions, which perform the steps when implemented by one or more processors. In yet further examples, subsystems or devices can be adapted to perform the recited steps. Other features, examples, and embodiments are described below.

### BRIEF DESCRIPTION OF THE DRAWINGS

Embodiments are illustrated by way of example, and not by limitation in the figures of the accompanying drawings, in which like references indicate similar elements and in which:

FIG. 1 shows an example system environment for providing a real time human-computer interface.

FIG. 2 is a general illustration of scene suitable for controlling an electronic device by way of recognition of gestures made by a user.

FIG. 3A shows a simplified view of an exemplary virtual skeleton associated with a user.

FIG. 3B shows a simplified view of an exemplary virtual skeleton associated with a user holding a handheld device.

FIG. 4 shows an environment suitable for implementing methods for determining a location and orientation of a handheld device.

FIG. 5 shows a simplified diagram of a handheld device, according to an example embodiment.

FIG. 6 is a process flow diagram showing a method for determining a location and optionally orientation of the handheld device, according to an example embodiment.

FIG. 7 is a diagrammatic representation of an example machine in the form of a computer system within which a set of instructions for the machine to perform any one or more of the methodologies discussed herein is executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is therefore not to be taken in a limiting sense, and the scope is defined by the appended claims and their equivalents. In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

The techniques of the embodiments disclosed herein may be implemented using a variety of technologies. For example, the methods described herein may be implemented in software executing on a computer system or in hardware utilizing either a combination of microprocessors or other specially designed application-specific integrated circuits (ASICs), programmable logic devices, or various combinations thereof. In particular, the methods described herein may be implemented by a series of computer-executable instructions residing on a storage medium such as a disk drive, or on a computer-readable medium.

Introduction

The embodiments described herein relate to computer-implemented methods and corresponding systems for determining and tracking the current location of a handheld device.

In general, one or more depth sensing cameras or 3D cameras (and, optionally, video cameras) can be used to generate a depth map of a scene which may be associated with a 3D coordinate system (e.g., a 3D Cartesian coordinate system). The depth map analysis and interpretation can be performed by a computing unit operatively coupled to or embedding the depth sensing camera. Some examples of computing units may include one or more of the following: a desktop computer, laptop computer, tablet computer, gaming console, audio system, video system, cellular phone, smart phone, personal digital assistant (PDA), set-top box (STB), television set, smart television system, or any other wired or wireless electronic device. The computing unit may include, or be operatively coupled to, a communication unit which may communicate with various handheld devices and, in particular, receive motion and/or orientation data of handheld devices.

The term “handheld device,” as used herein, refers to an input device or any other suitable remote controlling device which can be used for making an input. Some examples of handheld devices include an electronic pointing device, a remote controller, cellular phone, smart phone, video game console, handheld game console, game pad, computer (e.g., a tablet computer), and so forth. Some additional examples of handheld devices may include various non-electronic devices, such as sports implements, which may include, for example, a tennis racket, golf club, hockey or lacrosse stick, baseball bat, sport ball, etc. Regardless of what type of handheld device is used, it may include various removably attached motion (or inertial) sensors or imbedded motion (or inertial) sensors. The motion or inertial sensors may include, for example, acceleration sensors for measuring acceleration vectors in relation to an internal coordinate system, gyroscopes for measuring the orientation of the handheld device, and/or magnetometers for determining the direction of the handheld device with respect to a pole. In operation, the handheld device determines handheld device motion data (which include acceleration data) and handheld device orientation data (which include rotational data, e.g., an attitude quaternion), both associated with an internal coordinate system. Further, this handheld device motion data and orientation data are transmitted to the computing unit over a wired or wireless network for further processing.

It should be noted that, however, the handheld device may not be able to determine its exact location within the scene, or within the 3D coordinate system associated with the computing unit and/or the 3D camera. Although various geo-positioning devices, such as Global Positioning System (GPS) receivers, may be used in the handheld devices, the accuracy and resolution for determining its location within the scene is very low.

In operation, the computing unit processes and interprets the depth map obtained by the depth sensing camera or 3D camera such that it may identify at least a user, generate a corresponding virtual skeleton of the user, which skeleton includes multiple virtual “joints” associated with certain coordinates on the 3D coordinate system. The computing unit further determines that the user makes at least one motion (gesture) using his hand (or arm) which may hold the handheld device. The coordinates of every joint can be determined by the computing unit, and thus every user hand/arm motion can be tracked, and corresponding “first” motion data can be generated, which may include a velocity, acceleration, orientation, and so forth.

Further, when the computing unit receives the handheld device motion data and handheld device orientation data from the handheld device, it may associate the handheld device motion data with the 3D coordinate system utilizing the handheld device orientation data. The associated handheld device motion data will then be considered as “second” motion data. The associating process may include multiplying the handheld device motion data by the transformed handheld device orientation data. For example, the associating process may include multiplying the handheld device motion data by a rotation matrix, a instantaneous rotation matrix or a calibrated instantaneous rotation matrix all of which are based on the handheld device orientation data. In another example, the associating process may include multiplying the handheld device motion data by the calibrated instantaneous rotation matrix and by a predetermined calibration matrix.

Further, the computing unit compares the first motion data retrieved from the processed depth map to the second motion data obtained from the processed handheld device motion data and handheld device orientation data. When it is determined that the first motion data and second motion data coincide, are similar or in any other way correspond to each other, the computing unit determines that the handheld device is held by a corresponding arm or hand of the user. Since coordinates of the user's arm/hand are known and tracked, the same coordinates are then assigned to the handheld device. Therefore, the handheld device can be associated with the virtual skeleton of the user so that the current location of the handheld device can be determined and further monitored. In other words, the handheld device is mapped on the 3D coordinate system which is associated with the depth map.

Once the handheld device is associated with the user and/or user hand, movements of the handheld device may be further tracked in real time to identify particular user gestures. This may cause the computing unit to generate corresponding control commands. This approach can be used in various gaming and simulation/teaching software without a necessity to use immoderate computational resources, high resolution depth sensing cameras, or auxiliary devices (e.g., a lighting sphere) attached to or imbedded in the handheld device to facilitate its identification on the depth map. The technology described herein provides an easy and effective method for locating the handheld device on the scene, as well as for tracking its motions.

### Example Human-Computer Interface

Provided below is a detailed description of various embodiments related to methods and systems for determining a location of a handheld device within a 3D coordinate system.

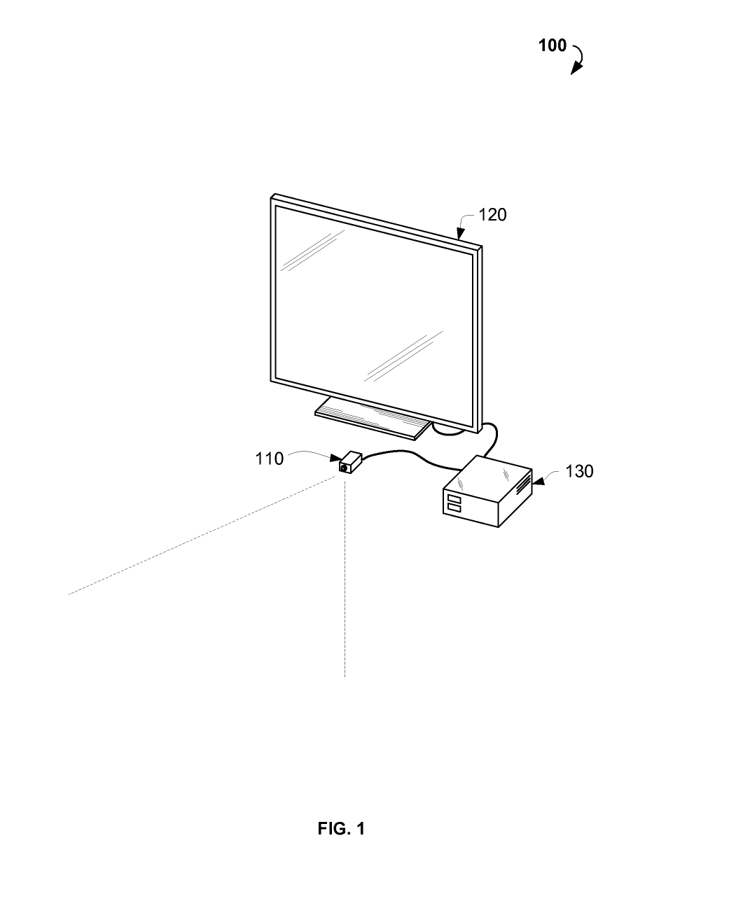

With reference now to the drawings, FIG. 1 shows an example system environment 100 for providing a real time human-computer interface. The system environment 100 includes a gesture recognition control system 110, a display device 120, and an entertainment system 130.

The gesture recognition control system 110 is configured to capture various user gestures/motions and user inputs, interpret them, and generate corresponding control commands, which are further transmitted to the entertainment system 130. Once the entertainment system 130 receives commands generated by the gesture recognition control system 110, the entertainment system 130 performs certain actions depending on which software application is running. For example, the user may control a cursor on the display screen by making certain gestures or by providing control commands in a computer game. As will be further described in greater details, the gesture recognition control system 110 may include one or more digital cameras such as a 3D camera or a depth sensing camera for obtaining depth maps.

The entertainment system 130 may refer to any electronic device such as a computer (e.g., a laptop computer, desktop computer, tablet computer, workstation, server), game console, television (TV) set, TV adapter, smart television system, audio system, video system, cellular phone, smart phone, and so forth. Although the figure shows that the gesture recognition control system 110 and the entertainment system 130 are separate and stand-alone devices, in some alternative embodiments, these systems can be integrated within a single device.

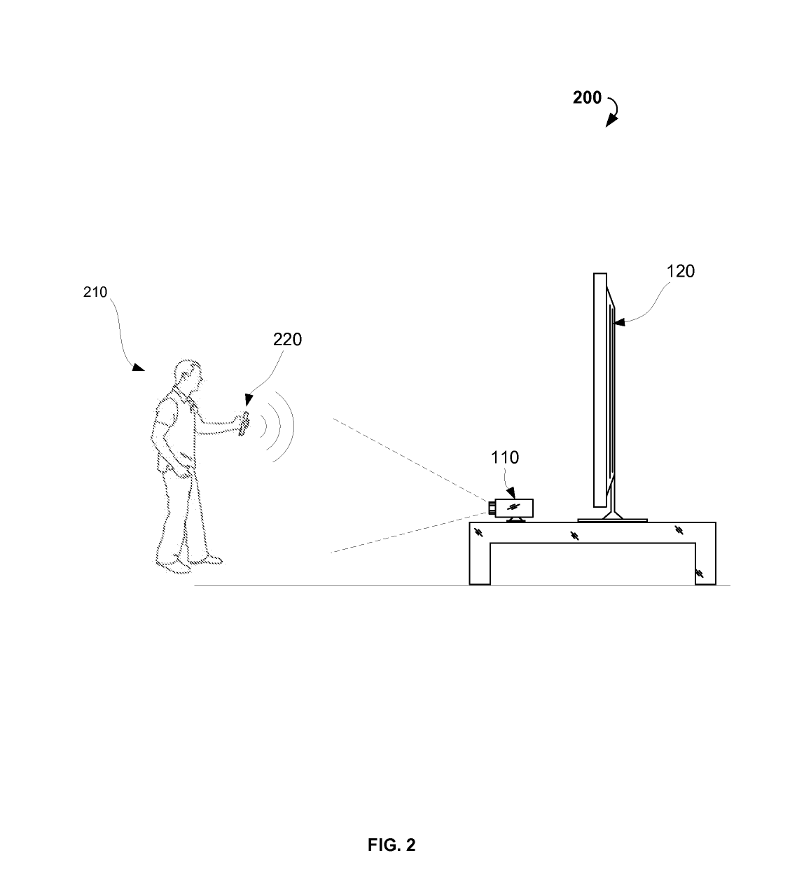

FIG. 2 is a general illustration of a scene 200 suitable for controlling an electronic device by recognition of gestures made by a user. In particular, this figure shows a user 210 interacting with the gesture recognition control system 110 with the help of a handheld device 220.

The gesture recognition control system 110 may include a depth sensing camera, a computing unit, and a communication unit, which can be stand-alone devices or embedded within a single housing (as shown). Generally speaking, the user and a corresponding environment, such as a living room, are located, at least in part, within the field of view of the depth sensing camera.

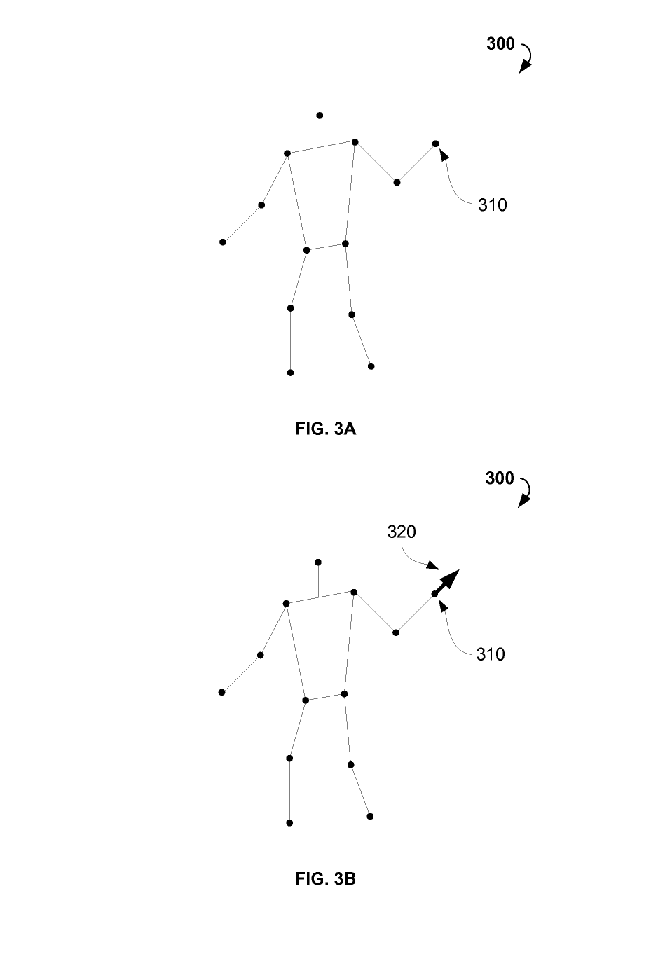

More specifically, the gesture recognition control system 110 may be configured to capture a depth map of the scene in real time and further process the depth map to identify the user, its body parts/limbs, determine one or more user gestures/motions, and generate corresponding control commands. The user gestures/motions may be represented as a set of coordinates on a 3D coordinate system which result from the processing of the depth map. The gesture recognition control system 110 may also optionally determine if the user holds the handheld device 220 in one of the hands, and if so, optionally determine the motion of the handheld device 220. The gesture recognition control system 110 may also determine specific motion data associated with user gestures/motions, wherein the motion data may include coordinates, velocity and acceleration of the user's hands or arms. For this purpose, the gesture recognition control system 110 may generate a virtual skeleton of the user as shown in FIG. 3 and described below in greater details.

As discussed above, the handheld device 220 may refer to a pointing device, controller wand, remote control device, a gaming console remote controller, game pad, smart phone, cellular phone, PDA, tablet computer, or any other electronic device enabling the user 210 to generate specific commands by pressing dedicated buttons arranged thereon. In certain embodiments, the handheld device 220 may also refer to non-electronic devices such as sports implements. The handheld device 220 is configured to generate motion and orientation data, which may include acceleration data and rotational data associated with an internal coordinate system, with the help of embedded or removably attached acceleration sensors, gyroscopes, magnetometers, or other motion and orientation detectors. The handheld device 220, however, may not determine its exact location within the scene and the 3D coordinate system associated with the gesture recognition control system 110. The motion and orientation data of the handheld device 220 can be transmitted to the gesture recognition control system 110 over a wireless or wired network for further processing. Accordingly, a communication module, which is configured to receive motion and orientation data associated with movements of the handheld device 220, may be imbedded in the gesture recognition control system 110.

When the gesture recognition control system 110 receives the motion data and orientation data from the handheld device 220, it may associate the handheld device motion data with the 3D coordinate system used in the gesture recognition control system 110 by transforming the handheld device motion data using the handheld device orientation data, and optionally with calibration data or correlation matrices. The transformed handheld device motion data (which is also referred to as “second motion data”) is then compared (mapped) to the motion data derived from the depth map (which is also referred to as “first motion data”). By the result of this comparison, the gesture recognition control system 110 may compare the motions of the handheld device 220 and the gestures/motions of a user's hands/arms. When these motions match each other or somehow correlate with or are similar to each other, the gesture recognition control system 110 acknowledges that the handheld device 220 is held in a particular hand of the user, and assigns coordinates of the user's hand to the handheld device 220. In addition to that, the gesture recognition control system 110 may determine the orientation of handheld device 220 on the 3D coordinate system by processing the orientation data obtained from the handheld device 220 and optionally from the processed depth map.

In various embodiments, this technology can be used for determining that the handheld device 220 is in “active use,” which means that the handheld device 220 is held by the user 210 who is located in the sensitive area of the depth sensing camera. In contrast, the technology can be used for determining that the handheld device 220 is in “inactive use,” which means that the handheld device 220 is not held by the user 210, or that it is held by a user 210 who is not located in the sensitive area of the depth sensing camera.

### Virtual Skeleton Representation

FIG. 3A shows a simplified view of an exemplary virtual skeleton 300 as can be generated by the gesture recognition control system 110 based upon the depth map. As shown in the figure, the virtual skeleton 300 comprises a plurality of virtual “bones” and “joints” 310 interconnecting the bones. The bones and joints, in combination, represent the user 210 in real time so that every motion of the user's limbs is represented by corresponding motions of the bones and joints.

According to various embodiments, each of the joints 310 may be associated with certain coordinates in the 3D coordinate system defining its exact location. Hence, any motion of the user's limbs, such as an arm, may be interpreted by a plurality of coordinates or coordinate vectors related to the corresponding joint(s) 310. By tracking user motions via the virtual skeleton model, motion data can be generated for every limb movement. This motion data may include exact coordinates per period of time, velocity, direction, acceleration, and so forth.

FIG. 3B shows a simplified view of exemplary virtual skeleton 300 associated with the user 210 holding the handheld device 220. In particular, when the gesture recognition control system 110 determines that the user 210 holds and the handheld device 220 and then determines the location (coordinates) of the handheld device 220, a corresponding mark or label can be generated on the virtual skeleton 300.

According to various embodiments, the gesture recognition control system 110 can determine an orientation of the handheld device 220. More specifically, the orientation of the handheld device 220 may be determined by one or more sensors of the handheld device 220 and then transmitted to the gesture recognition control system 110 for further processing and representation in the 3D coordinate system. In this case, the orientation of handheld device 220 may be represented as a vector 320 as shown in FIG. 3B.

### Example Gesture Recognition Control System

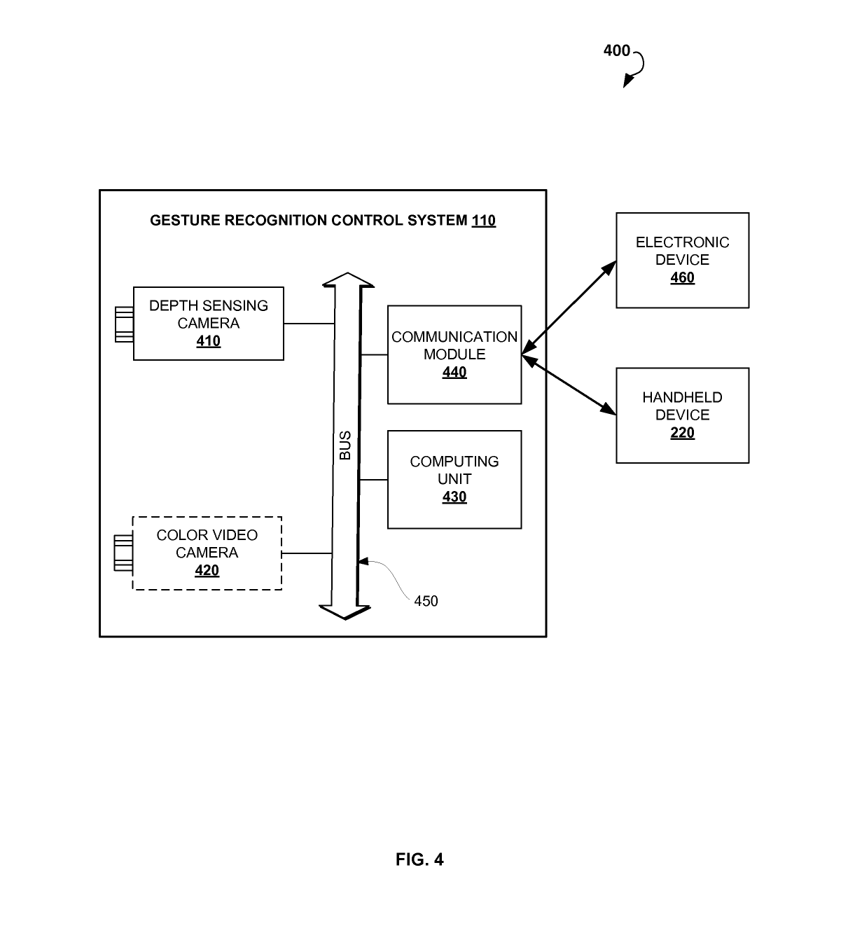

FIG. 4 shows an environment 400 suitable for implementing methods for determining a location of a handheld device 220. As shown in this figure, there is provided the gesture recognition control system 110, which may comprise at least one depth sensing camera 410 configured to capture a depth map. The term “depth map,” as used herein, refers to an image or image channel that contains information relating to the distance of the surfaces of scene objects from a depth sensing camera 410. In various embodiments, the depth sensing camera 410 may include an infrared (IR) projector to generate modulated light, and an IR camera to capture 3D images. Alternatively, the depth sensing camera 410 may include two digital stereo cameras enabling it to generate a depth map. In yet additional embodiments, the depth sensing camera 410 may include time-of-flight (TOF) sensors or integrated digital video cameras together with depth sensors.

In some example embodiments, the gesture recognition control system 110 may optionally include a color video camera 420 to capture a series of 2D images in addition to 3D imagery already created by the depth sensing camera 410. The series of 2D images captured by the color video camera 420 may be used to facilitate identification of the user, and/or various gestures of the user on the depth map. It should also be noted that the depth sensing camera 410 and the color video camera 420 can be either stand alone devices or be encased within a single housing.

Furthermore, the gesture recognition control system 110 may also comprise a computing unit 430 for processing depth map data and generating control commands for one or more electronic devices 460 (e.g., the entertainment system 130). The computing unit 430 is also configured to implement steps of particular methods for determining a location and/or orientation of the handheld device 220 as described herein.

The gesture recognition control system 110 also includes a communication module 440 configured to communicate with the handheld device 220 and one or more electronic devices 460. More specifically, the communication module 440 may be configured to wirelessly receive motion and orientation data from the handheld device 220 and transmit control commands to one or more electronic devices 460. The gesture recognition control system 110 may also include a bus 450 interconnecting the depth sensing camera 410, color video camera 420, computing unit 430, and communication module 440.

Any of the aforementioned electronic devices 460 can refer, in general, to any electronic device configured to trigger one or more predefined actions upon receipt of a certain control command. Some examples of electronic devices 460 include, but are not limited to, computers (e.g., laptop computers, tablet computers), displays, audio systems, video systems, gaming consoles, entertainment systems, lighting devices, cellular phones, smart phones, TVs, and so forth.

The communication between the communication module 440 and the handheld device 220 and/or one or more electronic devices 460 can be performed via a network (not shown). The network can be a wireless or wired network, or a combination thereof. For example, the network may include the Internet, local intranet, PAN (Personal Area Network), LAN (Local Area Network), WAN (Wide Area Network), MAN (Metropolitan Area Network), virtual private network (VPN), storage area network (SAN), frame relay connection, Advanced Intelligent Network (AIN) connection, synchronous optical network (SONET) connection, digital T1, T3, E1 or E3 line, Digital Data Service (DDS) connection, DSL (Digital Subscriber Line) connection, Ethernet connection, ISDN (Integrated Services Digital Network) line, dial-up port such as a V.90, V.34 or V.34bis analog modem connection, cable modem, ATM (Asynchronous Transfer Mode) connection, or an FDDI (Fiber Distributed Data Interface) or CDDI (Copper Distributed Data Interface) connection. Furthermore, communications may also include links to any of a variety of wireless networks including WAP (Wireless Application Protocol), GPRS (General Packet Radio Service), GSM (Global System for Mobile Communication), CDMA (Code Division Multiple Access) or TDMA (Time Division Multiple Access), cellular phone networks, Global Positioning System (GPS), CDPD (cellular digital packet data), RIM (Research in Motion, Limited) duplex paging network, Bluetooth radio, or an IEEE 802.11-based radio frequency network. The network can further include or interface with any one or more of the following: RS-232 serial connection, IEEE-1394 (Firewire) connection, Fiber Channel connection, IrDA (infrared) port, SCSI (Small Computer Systems Interface) connection, USB (Universal Serial Bus) connection, or other wired or wireless, digital or analog interface or connection, mesh or Digi® networking.

### Example Handheld Device

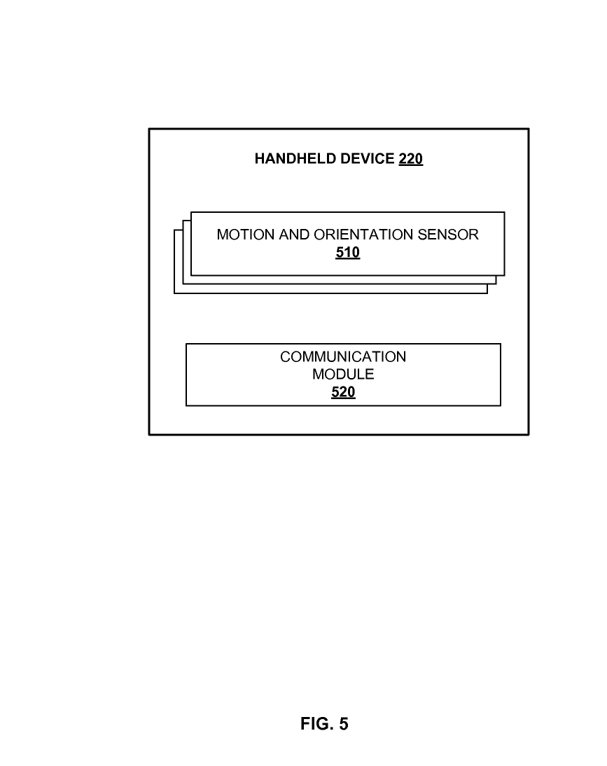

FIG. 5 shows a simplified diagram of the handheld device 220 according to an example embodiment. As shown in the figure, the handheld device 220 comprises one or more motion and orientation sensors 510, as well as a wireless communication module 520. In various alternative embodiments, the handheld device 220 may include additional modules (not shown), such as an input module, a computing module, a display, and/or any other modules, depending on the type of the handheld device 220 involved.

The motion and orientation sensors 510 may include gyroscopes, magnetometers, accelerometers, and so forth. In general, the motion and orientation sensors 510 are configured to determine motion and orientation data which may include acceleration data and rotational data (e.g., an attitude quaternion), both associated with an internal coordinate system. In operation, motion and orientation data is then transmitted to the gesture recognition control system 110 with the help of the communication module 520. The motion and orientation data can be transmitted via the network as described above.

### Example System Operation

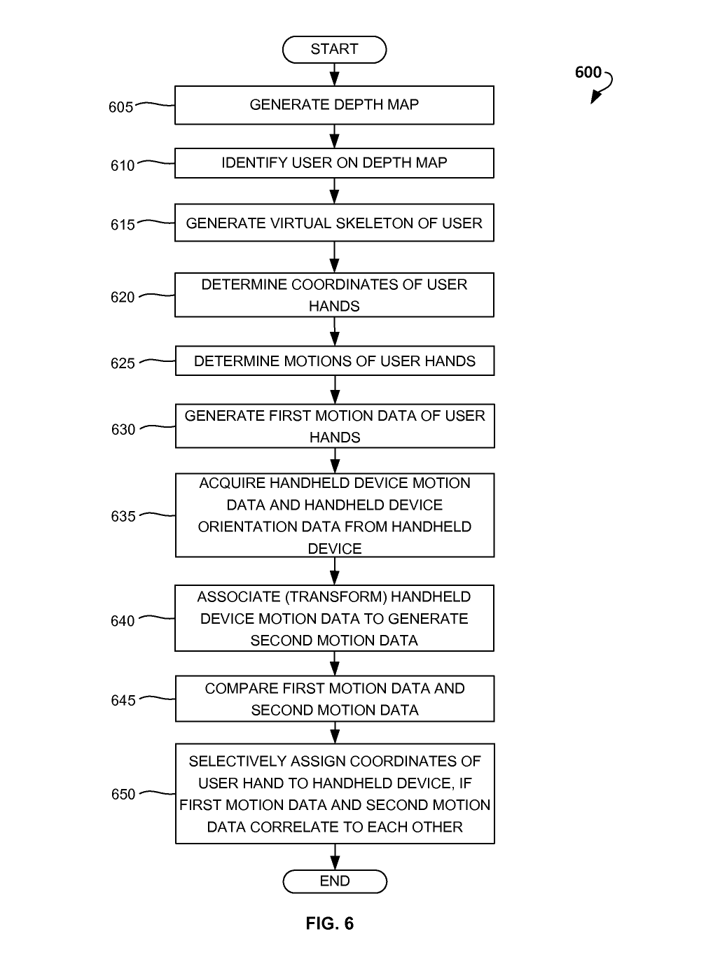

FIG. 6 is a process flow diagram showing an example method 600 for determining a location and optionally orientation of the handheld device 220 on a processed depth map, i.e. a 3D coordinate system. The method 600 may be performed by processing logic that may comprise hardware (e.g., dedicated logic, programmable logic, and microcode), software (such as software run on a general-purpose computer system or a dedicated machine), or a combination of both. In one example embodiment, the processing logic resides at the gesture recognition control system 110.

The method 600 can be performed by the units/devices discussed above with reference to FIG. 4. Each of these units or devices may comprise processing logic. It will be appreciated by one of ordinary skill in the art that examples of the foregoing units/devices may be virtual, and instructions said to be executed by a unit/device may in fact be retrieved and executed by a processor. The foregoing units/devices may also include memory cards, servers, and/or computer discs. Although various modules may be configured to perform some or all of the various steps described herein, fewer or more units may be provided and still fall within the scope of example embodiments.

As shown in FIG. 6, the method 600 may commence at operation 605, with the depth sensing camera 410 generating a depth map by capturing a plurality of depth values of scene in real time. The depth map may be associated with or include a 3D coordinate system such that all identified objects within the scene may have particular coordinates.

At operation 610, the depth map can be analyzed by the computing unit 430 to identify the user 210 on the depth map. At operation 615, the computing unit 430 segments the depth data of the user 210 and generates a virtual skeleton of the user 210.

At operation 620, the computing unit 430 determines coordinates of at least one of the user's hands (user's arms or user's limbs) on the 3D coordinate system. The coordinates of the user's hand can be associated with the virtual skeleton as discussed above.

At operation 625, the computing unit 430 determines a motion of the user's hand by processing a plurality of depth maps over a time period. At operation 630, the computing unit 430 generates first motion data of the user's hand associated with the 3D coordinate system.

At operation 635, the computing unit 430 acquires handheld device motion data and handheld device orientation data from the handheld device 220 via the communication module 440.

At operation 640, the computing unit 430 associates the handheld device motion data with the same 3D coordinate system. The associating may be performed by the computing unit 430 using the handheld device orientation data and optionally correlation parameters/matrices and/or calibration parameters/matrices so that the handheld device motion data corresponds to the 3D coordinate system and not to a coordinate system of the handheld device 220. In an example embodiment, the handheld device motion data is multiplied by a predetermined correlation (calibration) matrix and a current rotation matrix, where the current rotation matrix is defined by the handheld device orientation data, while the predetermined correlation (calibration) matrix may define correlation between two coordinate systems. As a result of multiplication, the transformed handheld device motion data (which is also referred herein to “second motion data”) is associated with the 3D coordinate system.

At operation 645, the computing unit 430 compares the second motion data to the first motion data. If the first and second motion data correspond (or match or are relatively similar) to each other, the computing unit 430 selectively assigns the coordinates of the user's hand to the handheld device 220 at operation 650. Thus, the precise location of handheld device 220 is determined on the 3D coordinate system. Similarly, precise orientation of handheld device 220 may be determined on the 3D coordinate system.

Further, the location of handheld device 220 can be tracked in real time so that various gestures can be interpreted for generation of corresponding control commands for one or more electronic devices 460.

In various embodiments, the described technology can be used for determining that the handheld device 220 is in active use by the user 210. As mentioned earlier, the term “active use” means that the user 210 is identified on the depth map (see operation 620) or, in other words, is located within the viewing area of depth sensing camera 410 when the handheld device 220 is moved.

### Example Computing Device

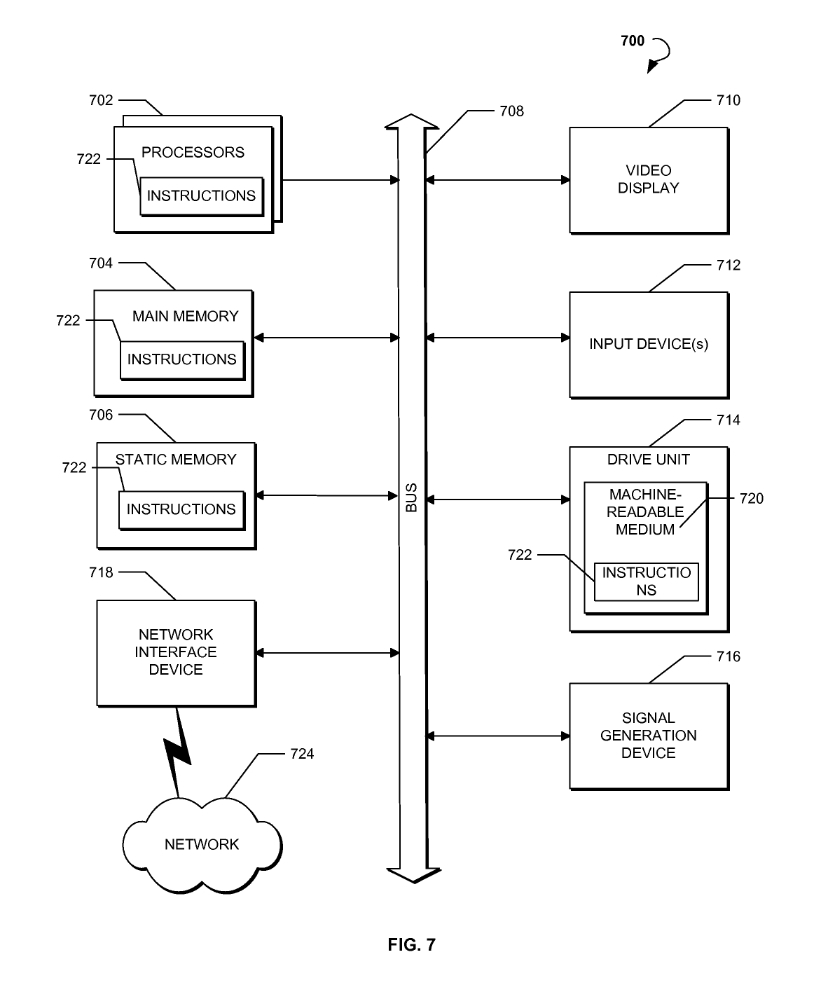

FIG. 7 shows a diagrammatic representation of a computing device for a machine in the example electronic form of a computer system 700, within which a set of instructions for causing the machine to perform any one or more of the methodologies discussed herein can be executed. In example embodiments, the machine operates as a standalone device, or can be connected (e.g., networked) to other machines. In a networked deployment, the machine can operate in the capacity of a server, a client machine in a server-client network environment, or as a peer machine in a peer-to-peer (or distributed) network environment. The machine can be a personal computer (PC), tablet PC, STB, PDA, cellular telephone, portable music player (e.g., a portable hard drive audio device, such as a Moving Picture Experts Group Audio Layer 3 (MP3) player), web appliance, network router, switch, bridge, or any machine capable of executing a set of instructions (sequential or otherwise) that specify actions to be taken by that machine. Further, while only a single machine is illustrated, the term “machine” shall also be taken to include any collection of machines that separately or jointly execute a set (or multiple sets) of instructions to perform any one or more of the methodologies discussed herein.

The example computer system 700 includes one or more processors 702 (e.g., a central processing unit (CPU), graphics processing unit (GPU), or both), main memory 704, and static memory 706, which communicate with each other via a bus 708. The computer system 700 can further include a video display unit 710 (e.g., a liquid crystal display (LCD) or cathode ray tube (CRT)). The computer system 700 also includes at least one input device 712, such as an alphanumeric input device (e.g., a keyboard), cursor control device (e.g., a mouse), microphone, digital camera, video camera, and so forth. The computer system 700 also includes a disk drive unit 714, signal generation device 716 (e.g., a speaker), and network interface device 718.

The disk drive unit 714 includes a computer-readable medium 720 that stores one or more sets of instructions and data structures (e.g., instructions 722) embodying or utilized by any one or more of the methodologies or functions described herein. The instructions 722 can also reside, completely or at least partially, within the main memory 704 and/or within the processors 702 during execution by the computer system 700. The main memory 704 and the processors 702 also constitute machine-readable media.

The instructions 722 can further be transmitted or received over the network 724 via the network interface device 718 utilizing any one of a number of well-known transfer protocols (e.g., Hyper Text Transfer Protocol (HTTP), CAN, Serial, and Modbus).

While the computer-readable medium 720 is shown in an example embodiment to be a single medium, the term “computer-readable medium” should be understood to include a either a single medium or multiple media (e.g., a centralized or distributed database, and/or associated caches and servers), either of which store the one or more sets of instructions. The term “computer-readable medium” shall also be understood to include any medium that is capable of storing, encoding, or carrying a set of instructions for execution by the machine, and that causes the machine to perform any one or more of the methodologies of the present application. The “computer-readable medium may also be capable of storing, encoding, or carrying data structures utilized by or associated with such a set of instructions. The term “computer-readable medium” shall accordingly be understood to include, but not be limited to, solid-state memories, and optical and magnetic media. Such media may also include, without limitation, hard disks, floppy disks, flash memory cards, digital video disks, random access memory (RAM), read only memory (ROM), and the like.

The example embodiments described herein may be implemented in an operating environment comprising computer-executable instructions (e.g., software) installed on a computer, in hardware, or in a combination of software and hardware. The computer-executable instructions may be written in a computer programming language or may be embodied in firmware logic. If written in a programming language conforming to a recognized standard, such instructions may be executed on a variety of hardware platforms and for interfaces associated with a variety of operating systems. Although not limited thereto, computer software programs for implementing the present method may be written in any number of suitable programming languages such as, for example, C, C++, C#, Cobol, Eiffel, Haskell, Visual Basic, Java, JavaScript, or Python, as well as with any other compilers, assemblers, interpreters, or other computer languages or platforms.

Thus, methods and systems for determining a location and orientation of a handheld device have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A method for determining a location of a handheld device within a three-dimensional (3D) environment, the method comprising:
acquiring, by a processor communicatively coupled with a memory, a depth map from at least one depth sensing device, wherein the depth map is associated with a first coordinate system;
processing, by the processor, the depth map to identify at least one motion of at least one user hand;
generating, by the processor, first motion data associated with the at least one motion of the at least one user hand;
acquiring, by the processor, handheld device motion data and handheld device orientation data associated with at least one motion of the handheld device;
generating, by the processor, second motion data based at least in part on the handheld device motion data and the handheld device orientation data;
comparing, by the processor, the first motion data to the second motion data to determine that the at least one motion of the handheld device is correlated with the at least one motion of the at least one user hand; and
based on the determination, ascertaining, by the processor, coordinates of the handheld device on the first coordinate system.

2. The method of claim 1, wherein the first motion data includes a set of coordinates associated with the at least one user hand.

3. The method of claim 2, wherein the ascertaining of the coordinates of the handheld device on the first coordinate system includes assigning, by the processor, the set of coordinates associated with the at least one user hand to the handheld device.

4. The method of claim 1, wherein the second motion data is associated with the first 3D coordinate system.

5. The method of claim 1, wherein the handheld device motion data and the handheld device orientation data are associated with a second coordinate system.

6. The method of claim 5, wherein the generating of the second motion data comprises multiplying, by the processor, the handheld device motion data by a correlation matrix and a rotation matrix, wherein the rotation matrix is associated with the handheld device orientation data.

7. The method of claim 1, further comprising determining, by the processor, one or more orientation vectors of the handled device within the first coordinate system based at least in part on the handheld device orientation data.

8. The method of claim 1, further comprising generating, by the processor, a virtual skeleton of a user, the virtual skeleton comprises at least one virtual joint of the user; wherein the at least one virtual joint of the user is associated with the first coordinate system.

9. The method of claim 8, wherein the processing of the depth map further comprises determining, by the processor, coordinates of the at least one user hand on the first coordinate system, wherein the coordinates of the at least one user hand are associated with the virtual skeleton.

10. The method of claim 8, wherein the processing of the depth map further comprises determining, by the processor, that the at least one user hand, which makes the at least one motion, holds the handheld device.

11. The method of claim 1, wherein the second motion data includes at least acceleration data.

12. The method of claim 1, wherein the handheld device orientation data includes at least one of: rotational data, calibrated rotational data or an attitude quaternion associated with the handheld device.

13. The method of claim 1, further comprising determining, by the processor, that the handheld device is in active use by the user, wherein the handheld device is in active use by the user, when the handheld device is held and moved by the user and when the user is identified on the depth map.

14. The method of claim 1, further comprising generating, by the processor, a control command for an auxiliary device based at least in part on the first motion data or the second motion data.

15. A system for determining a location of a handheld device within a 3D environment, the system comprising:
a depth sensing device configured to obtain a depth map of the 3D environment within which at least one user is present;
a wireless communication module configured to receive from the handheld device handheld device motion data and handheld device orientation data associated with at least one motion of the handheld device; and
a computing unit communicatively coupled to the depth sensing device and the wireless communication unit, the computing unit is configured to:
identify, on the depth map, a motion of at least one user hand;
determine, by processing the depth map, coordinates of the at least one user hand on a first coordinate system;
generate first motion data associated with the at least one motion of the user hand, wherein the first motion data is associated with the coordinates of the at least one user hand on the first coordinate system;
generate second motion data by associating the handheld device motion data with the first coordinate system;
compare the first motion data and the second motion data so as to determine correlation therebetween; and
based on the correlation, assign the coordinates of the at least one user hand on the first coordinate system to the handheld device.

16. The system of claim 15, wherein the handheld device is selected from a group comprising: an electronic pointing device, a cellular phone, a smart phone, a remote controller, a video game console, a video game pad, a handheld game device, a computer, a tablet computer, and a sports implement.

17. The system of claim 15, wherein the depth map is associated with the first coordinate system, and wherein the handheld device motion data and the handheld device orientation data are associated with a second coordinate system.

18. The system of claim 17, wherein the associating of the handheld device motion data with the first coordinate system includes transforming the handheld device motion data based at least in part on handheld device orientation data.

19. The system of claim 15, wherein the computing unit is further configured to:
generate a virtual skeleton of the user, the virtual skeleton comprising at least one virtual limb associated with the at least one user hand;
determine coordinates of the at least one virtual limb; and
associate the coordinates of the at least one virtual limb, which relates to the user hand making the at least one motion, to the handheld device.

20. A non-transitory processor-readable medium having instructions stored thereon, which when executed by one or more processors, cause the one or more processors to implement a method for determining a location of a handheld device within a 3D environment, the method comprising:
acquiring a depth map from at least one depth sensing device, wherein the depth map is associated with a first coordinate system;
processing the depth map to identify at least one motion of at least one user hand;
generating first motion data associated with the at least one motion of the at least one user hand;
acquiring handheld device motion data and handheld device orientation data associated with at least one motion of the handheld device;
generating second motion data based at least in part on the handheld device motion data and the handheld device orientation data;
comparing the first motion data to the second motion data to determine that the at least one motion of the handheld device is correlated with the at least one motion of the at least one user hand; and
based on the determination, ascertaining coordinates of the handheld device on the first coordinate system.
